(19) United States
(12) Patent Application Publication
(10) Pub. No.: US 2020/0087328 A1
(43) Pub. Date: Mar. 19, 2020

(54) A TITANIUM-ORGANIC FRAMEWORK MATERIAL

(71) Applicant: CENTER FOR INNOVATIV MATERIALS & ARCHITECTURES, Ho Minch City (VN)

(72) Inventors: Ha Lac Nguyen, Ho Chi Minh City (VN); Thanh Trong Vu, Ho Chi Minh City (VN); Dinh Quoc Le, Ho Chi Minh City (VN); Tan Le Hoang Doan, Ho Chi Minh City (VN); Viet Quoc Nguyen, Ho Chi Minh City (VN); Nam Thanh Son Phan, Ho Chi Minh City (VN)

(21) Appl. No.: 16/312,853

(22) PCT Filed: Jan. 24, 2018
(86) PCT No.: PCT/VN2018/000002

§ 371 Date: Dec. 21, 2018

(30) Foreign Application Priority Data
Jan. 25, 2017 (VN) 1-2017-00351

(51) Int. Cl. C07F 7/28; C08F 4/16

(52) U.S. Cl. CPC C07F 7/28; C08F 4/16

(57) ABSTRACT

This patent mentioned the synthesis of new metal-organic framework based on hexameric titanium-oxo cluster. The novel material, termed MOF-902, was successfully synthesized and its crystal structure uncovered the 2-Dimensional (2D) layer structure generated by the link of trigonal prism Ti₆O₆(OMe)(—COO)₆ clusters and imine linear linking units. The permanent porosity of MOF-902 is 400 m² g⁻¹. The band gap energy of this material was found to be 2.5 eV which is suitable to catalyze the polymerization reaction of methacrylate monomers under visible irradiation.

### FIELD OF INVENTION

This invention belongs to chemistry and materials science. Indeed, the invention is presented the work for Metal-organic frameworks, MOFs, based on titanium-oxo cluster.

### BACKGROUND OF THE INVENTION

Metal-organic frameworks are made up of metal centers which are linked together by the linking units containing phosphonate, carboxylate or sulfonate bridges forming three-dimensional extended structure with high porosity and stable frameworks. External factors such as pressure, temperature, light, or influence of gases and solvents can cause the opening or closing of the structure. The framework structures of the materials are highly stable due to the rigid of covalent bond between metal and oxygen bonding. This material is crystalline microporous with low density and high surface area and is used in various fields such as environment, energy, catalysis, biomedical applications.

US 2012/0121904 A1 discloses titanium based inorganic-organic hybrid solid material, method for preparing same and uses thereof.

“A Flexible Photoactive Titanium Metal-Organic Framework Based on a [Ti(IV)₃(μ₃-OXO)₂(COO)₆] Cluster” reported by Bueken et al. in 2015. In that report, Ti-based MOF was synthesized and termed COK-69, constructed from trans-1,4-cyclohexanedicarboxylate linking unit and triangular [Ti(IV)₃(μ₃-OX)(O)₂(COO)₆] cluster. Band gap energy of COK-69 was found to be 3.77 eV which is useful for the reaction of alcohol oxidation in which the valent transforming of triangular-Ti cluster, Ti(IV) to Ti(III), was observed.

Mason et al. reported the research of “Synthesis and O₂ Reactivity of a Titanium(III) Metal-Organic Framework” in 2015. In this research, Ti-MOF material with the formula of Ti₃O(OEt)(bdc)₃(solv) (bdc²⁻=1,4-benzenedicarboxylate, solv=N,N-dimetylformamide (DMF), tetrahydrofuran (THF)), possessing high surface area, based on triangular Ti(III) cluster was synthesized. The crystal structure of this MOF revealed the presence of titanium(IV) superoxo and peroxo species which were generated by the strong interaction of O₂ with Ti(III) atom.

U.S. Pat. No. 9,284,282 B2 describes 1,2,3-triazole based metal-organic framework as photo-active materials.

### SUMMARY OF THE INVENTION

The purpose of the invention is to synthesize a 2D layer structure of a metal-organic framework material containing a hexagonal prismatic Ti-oxo cluster. This material can catalyze the catalytic reaction of organic synthesis. For that purpose, the metal-organic framework according to the invention (MOF 902) has an infinite two-dimensional structure with staggered layers. The second layer slides a certain distance so that the hexagonal Ti-oxo prismatic cluster arrays at the center of the triangle window of the first layer. Ti-oxo clusters are linked together via an imine linkage (HC═N—). Each titanium atom directly binds to a methoxide (—OCH₃) group to meet the charge balance.

### BRIEF DESCRIPTION OF THE DRAWINGS

FIG. 1: The synthetic scheme of MOF-902

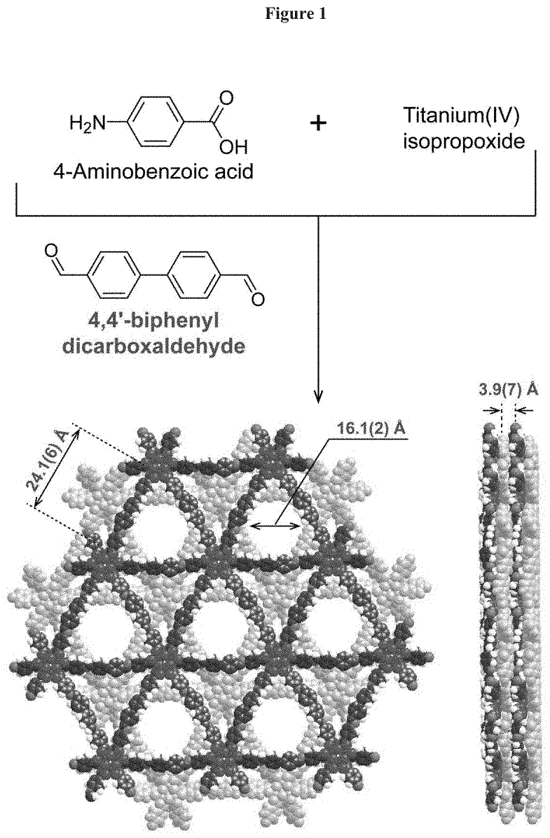

FIG. 2: The hexameric Ti-oxo cluster and imine linking unit in MOF-902 structure

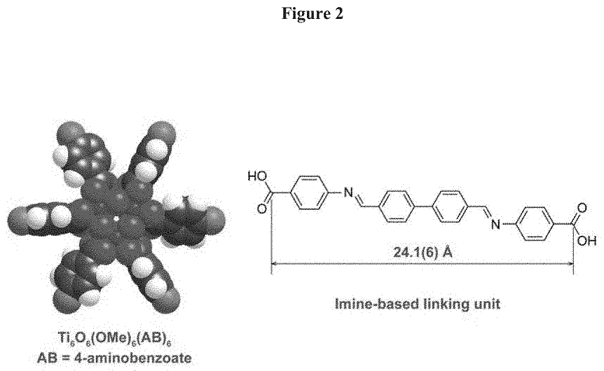

### DETAILED DESCRIPTION

Crystal structure of MOF-902 is determined by powder X-ray diffraction (CuKα, λ=1.5459 Å) and model simulation followed by refinement. The details of crystal structure described below are based on the single crystal structural model. Metal-organic framework-902 material (MOF 902) contains staggered layers which is infinite two-dimensional structure. The distance between the two layers is about 3.9(7) Å (tolerance error ±0.7), the pore size is about 16.1(2) Å (tolerance range ±0.2). The Ti-oxo metal clusters are arranged by alternately arrangement of titanium and oxygen to form a hexagonal prism. The bonding distribution in Ti-oxo cluster was found to be Ti—O—Ti—O—Ti—O. The distance of Ti—O bonding was approximately found to be 1.87(7) Å (an error tolerance of ±0.07). Ti-oxo clusters bind together via an imine linking units which possess imine functionality (HC═N—) and the length of the organic linker is about 24.1(6) Å (error range ±0.6). For meeting charge balance (to preserve tetravalence), each titanium atom links directly to an additional group of methoxides (—OCH₃). MOF-902 is capable of receiving energy from visible light irradiation and catalyzes for the polymerization reaction. The band-gap energy of MOF-902 was found to be 2.5 eV which is benefit to promote the synthesis of polymers from monomers such as methylmethacrylate (MMA), benzylmethacrylate (BMA), or Styrene (St). Under MOF-902 photocatalyst, the resulting polymers exhibited its uniform as proven by high molecular weight and low dispersion index (PDI).

Synthesis of MOF-902

MOF-902 was synthesized by solvothermal method. In general, 4-aminobenzoic acid, titanium(IV) isopropoxide, and 4,4′-biphenyldicarboxaldehyde were mixed together under methanoic solution. The mixture was then transferred to the teflon container of Autoclave reactor and place in the isothermal oven which the temperature is set up at 140° C. for 3 days. The reaction was cooled down to room temperature and the yellow crystalline powder was collected by filtration.

MOF-902 absorbs the visible light with a broad range of optical absorption from 340 nm to 640 nm, in which the maximum absorption located at 390 nm. The band-gap energy of MOF-902 was calculated based on UV-vis diffuse reflectance spectroscopy corresponding to 2.5 eV. MOF-902 exhibits thermal stability at 200° C. The internal surface area of MOF-902 based on BET method is 400 m² g⁻¹. MOF-902's density was found to be 0.95 g cm⁻³. The elemental analysis reveals the formula of MOF-902 is Ti₆O₂₄C₉₀H₇₂N₆(Ti: ˜15.0%, C: ˜57.0%, H: ˜4.0%, N; ˜4.0%/).

Polymers Preparation by MOF-902 Catalyst

Step 1: Charge the monomer (methylmethacrylat (MMA), benzylmethacrylat (BMA), or Styren (St)) into the vial which contains MOF-902 catalyst.

Step 2: The organic solvent (N,N-Dimethylformamide (DMF), 1,4-dioxane, or tetrahydrofuran (THF)) was then added to the reaction mixture. The vial was sealed by septum and parafilm to prevent the reaction from the air.

Step 3: The reaction mixture was frozen under liquid nitrogen bath and evacuated 3 times under reduced pressure by a Schlenk line system. Ethyl α-bromophenylacetate (co-initiator) was then introduced to the reaction by a micro injector.

Step 4: The reaction mixture was stirred at room temperature 30 minutes before irradiated by a compact fluorescent light bulb 4U, 55W for 18 h. Polymer product was precipitated by methanol. The product was washed 3 times with methanol. MOF-902 catalyst was collected by centrifugation and immersed in DMF and dichloromethane before regeneration.

### EXAMPLES OF THE PRESENT INVENTION

### Example 1: Prepare 100 mg MOF-902

4,4′-Biphenyldicarboxaldehyde (147.2 mg, 0.701 mmol) was dispersed in 6 mL methanol and sonicated for 2 minutes. This dispersion was then transferred to 6 mL methanoic solution dissolving 4-aminobenzoic acid (192 mg, 1.401 mmol) and titanium(IV)isopropoxide (104 μL, 0.352 mmol). The mixture was subsequently introduced to a teflon container of autoclave reactor and heated up to 140° C. for 3 days. The yellow crystalline powder of MOF-902 was collected and washed with N,N-dimethylacetamide (DMA) for 2 days with 4 times of replenishment solvent per day. MOF-902 was then immersed in dichloromethane for 3 days with 3 times of replenishment solvent per day. Activated MOF-902 was obtained after evacuation at low pressure and 130° C. for 24 hours.

### Example 2: Prepare Polymethylmethacrylate (polyMMA)

The photocatalytic activity of MOF-902 was studied as follow: an activated MOF-902 (6.6 mg, 0.0038 mmol based on MOF-902 molecule mass) was loaded into a 8 mL glass vial. The mixture of methylmethacrylate (MMA) (602 μL, 0.00570 mol) and 2.1 mL of DMF (0.0271 mol) was then introduced to the vial containing MOF-902 catalyst. The vial was sealed with a rubber septum and evacuated 3 times under reduced pressure by a Schlenk line system. Next, 4.5 μL of ethyl α-bromophenylacetate (0.024 mmol) was then introduced to the vial by a micro injector. The reaction solution was stirred for 30 min before irradiating 18 h with a compact fluorescent light bulb (4U, 55W) with speed at 1000 rpm. After 18 hours, the reaction vial was wrapped with an aluminum foil and allowed to stand for 1 hour. The catalyst was isolated by centrifugation and washed with dichloromethane several times before immersing to methanol 5 hours. MOF-902 was subsequently regenerated under vacuum medium (1 mTorr). The polyMMA product was crystallized in 80 mL methanol. The product was washed with methanol several times and evacuated at room temperature for 2 hours. The yield of polyMMA product was found to be in the rage from 50% to 84% depends on the nanoparticle size of MOF-902.

Uses of Invention (MOF-902)

MOF-902 as described above may be used as photocatalyst for organic synthesis of polymerization reactions. The quality of polymers is higher than using existing commercial catalysts such as P25-TiO₂ or other related MOF catalysts (MIL-125, MIL-125-NH₂, UiO-66 type). The quality of the polymers can be improved and the cost of product preparation can be reduced due to the reusable nature of MOF-902 catalyst which can be recycled at least 5 times without reducing the activity. In addition, this material possesses centers of active site which catalyze the polymerization reaction based on the free radical mechanism, overcoming the disadvantages of published catalysts in the ability to regulate the mass of resulting polymer products with low dispersion index (PDI, which is an indicator of the uniform distribution of polymers). The synthesis of polymers such as polymethylmethacrylate, polybenzylmethacrylate, or polystyrene under fluorescent lamps in the presence of MOF-902 catalyst can be produced industrially large scale.

The invention claimed is:

1. A metal organic framework material, MOF-902, possessing 2D layer structure comprises Ti-oxo clusters and imine linking units; wherein every titanium atom links directly to a methoxide group (—OCH₃); and wherein the Ti-oxo clusters connected together through the imine linking units containing (HC═N—) linkage.

2. The metal organic framework material according to claim 1 further contains staggered layers which is infinite two-dimensional structure.

3. The metal organic framework material according to claim 1 further contains staggered layers, wherein the distance between two layers of the material is about 3.9(7) Å, having tolerance range of ±0.7; and wherein a second layer of the material moving a certain distance leading to place the Ti-oxo clusters in the center of triangular pores of the first layer providing a hexagonal pore size about 16.1(2) Å with a tolerance range of ±0.2.

4. The metal organic framework material according to claim 1, wherein the bonding distribution in Ti-oxo cluster of the material is Ti—O—Ti—O—Ti—O.

5. The metal organic framework material according to claim 4, wherein the Ti—O linkage is a covalent bond; and wherein the distance of the Ti—O linkage is approximately 1.87(7) Å with a tolerance range of ±0.07.

6. The metal organic framework material according to claim 1, wherein the Ti-oxo clusters bind together via an imine linking unit which possesses imine functionality (HC═N—), and wherein the length of the organic linker is about 24.1(6) Å with a tolerance range of ±0.6.

7. The metal organic framework material according to claim 1 having a formula of Ti₆O₂₄C₉₀H₇₂N₆ (Ti: ˜15.0%, C: ˜57.0%, H: ˜4.0%, N; ˜4.0%).

8. The metal organic framework material according to claim 1 wherein the linking units comprise 4,4′-biphenyldicarboxaldehyde.

9. The metal organic framework material according to claim 6 wherein the linking units comprise 4,4′-biphenyldicarboxaldehyde.
